(19) United States
(12) Patent Application Publication
(10) Pub. No.: US 2012/0308856 A1
(43) Pub. Date: Dec. 6, 2012

(54) SHUNT CURRENT RESISTORS FOR FLOW BATTERY SYSTEMS

(75) Inventors: Craig R. Horne, Sunnyvale, CA (US); Jay E. Sha, Sunnyvale, CA (US); Ronald J. Mosso, Fremont, CA (US); William D. Lyle, San Francisco, CA (US)

(73) Assignee: Enervault Corporation, Sunnyvale, CA (US)

(21) Appl. No.: 13/312,802

(22) Filed: Dec. 6, 2011

Related U.S. Application Data
(60) Provisional application No. 61/421,049, filed on Dec. 8, 2010.

(51) Int. Cl. H01M 2/38; H01M 10/48

(52) U.S. Cl. 429/72; 429/101; 429/90

(57) ABSTRACT

Shunt currents in electrochemical systems with liquid electrolytes are reduced by placing shunt resistors in electrolyte flow paths. Shunt resistors substantially increase electrical resistance in electrolyte flow channels by interrupting the physical continuity of liquid through their length. Some shunt resistors also provide a flow metering, pumping or flow-resisting functions for improved electrolyte flow control.

### CROSS-REFERENCE TO RELATED APPLICATIONS

This application claims the benefit of U.S. Provisional Patent Application 61/421,049, filed Dec. 8, 2010, the entire contents of which are incorporated herein by reference.

This application is also related to U.S. patent application Ser. No. 12/498,103, filed on Jul. 6, 2009, now U.S. Pat. No. 7,820,321 which claims the benefit of U.S. Provisional Patent Application No. 61/078,691 filed Jul. 7, 2008 and U.S. Provisional Patent Application No. 61/093,017 filed Aug. 29, 2008, the entire contents of all the above patent applications are hereby incorporated herein by reference.

### STATEMENT OF FEDERALLY FUNDED RESEARCH

Inventions included in this patent application were made with Government support under DE-OE0000225 “Recovery Act—Flow Battery Solution For Smart Grid Renewable Energy Applications” awarded by the US Department of Energy (DOE). The Government has certain rights in these inventions.

### FIELD

This application generally relates to energy storage technologies, and more particularly to systems and methods for reducing shunt currents in energy storage systems with a flowing liquid electrolyte.

### BACKGROUND

As described in U.S. patent application Ser. No. 12/498,103, filed on Jul. 6, 2009 and issued as U.S. Pat. No. 7,820,321, redox (reduction-oxidation) flow batteries store electrical energy in two liquid electrolyte species. Redox batteries function as a bulk energy storage system of electric energy and have a low cost as compared to many other systems. The storage of energy takes place through the solutions of metal ion pairs at differing states of oxidation. If two such ion pairs, whose “redox” potentials deviate sufficiently each other, are allowed to react on two different electrodes that are separated from each other by a membrane, then a potential difference is obtained, i.e. electric energy.

Many such redox pairs have been identified and utilized as the basis for redox flow battery systems. Since the energy produced by a single redox cell is generally too low for technical applications, several redox cells are typically electrically connected in series to form a flow battery stack capable of storing or delivering energy at a desired voltage.

In flow battery systems having a plurality of cells with at least one common liquid electrolyte, shunt current losses are known to be a problem. Shunt currents are a form of short-circuit caused by electrical currents flowing through the conductive liquid electrolyte resulting in a consumption of available discharge energy or delivered charge energy. Such shunt current losses are present in these devices during charging, discharging and/or under open circuit conditions. Shunt currents have undesirable side effects leading to the loss of usable energy and potentially shortening of the battery's useful life. It is desirable to limit shunt currents to minimize these and other negative impacts.

One known method of managing shunt currents involves creating long, small-cross-section flow channels. Flow channels with sufficient length and a sufficiently small cross section will create a substantially high electrical resistance from one end of the channel to the other. Unfortunately, such long channels also create a high pressure drop. A high pressure drop increases pumping requirements and system fluid pressures, increasing cost and complexity of other aspects of the system.

### SUMMARY

Embodiments of devices, systems and methods for mitigating, reducing or eliminating shunt currents without substantially increasing system pressure or complexity are shown and described herein.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a schematic illustration of a redox flow battery with a single block of electrochemical cells having shunt resistors positioned in common inlet and outlet lines.

FIG. 2 is a schematic illustration of a redox flow battery system comprising a plurality of electrochemical cell blocks arranged in hydraulic series with one another, each block having cells in hydraulic parallel.

FIG. 3 is a cross-sectional view of an embodiment of a shunt resistor device comprising a plurality of dividers in a flow channel.

FIG. 4 is a cross-sectional view of the device of FIG. 3 taken through section A-A.

FIG. 5 is a partially-transparent perspective view of an embodiment of a shunt resistor configured to provide a variable resistance to fluid flow through it.

FIG. 6 is a schematic sketch of a redox flow battery stack assembly with check valves positioned at inlets and outlets of each cell.

FIG. 7 is a perspective view of an embodiment of a shunt valve with a rotating central control cylinder.

FIG. 8 is a perspective, cut-away view of a progressing cavity pump.

FIG. 9 is a side, cut-away view of a vane-type positive-displacement pump.

FIG. 10 is a sequence of vane positions in a side, cut-away view of a vane-type positive-displacement pump.

FIG. 11 is a side, cut-away view of a gear pump with two enmeshed round spur gears.

FIG. 12 is a sequence of operation in a side, cut-away view of an oval gear pump.

FIG. 13 is a side, cut-away view of a toothed oval gear pump.

FIG. 14 is a side, cut-away view of a nutating disk flow meter.

### DETAILED DESCRIPTION

Embodiments of devices, systems and methods for mitigating, reducing or eliminating shunt currents are described herein with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The embodiments discussed herein provide systems, devices and methods useful in energy storage system based upon a reduction/oxidation (redox) flow battery system that is suitable for storing and delivering electric energy under a wide variety of conditions. Embodiments of such redox flow battery systems are shown and described in co-pending U.S. patent application Ser. No. 12/498,103, filed on Jul. 6, 2009, the entire contents of which are hereby incorporated herein by reference. The embodiments described herein may also be applied to other electrochemical energy storage systems having at least one liquid electrolyte.

Shunt currents are parasitic currents that occur in certain electrochemical systems through an electrically-conducting pathway existing within a potential difference. In some electrochemical systems, a continuous flow channel of liquid electrolyte may provide an electrically-conductive pathway. In a system in which electrolytes flow through an electrochemical cell while reacting, electrolytes entering the cell will have a higher or lower electric potential than electrolytes leaving the cell. Connecting more than one cell in hydraulic series connection may cause an even greater difference in electric potential. The magnitude of a shunt current in an electrolyte flow stream may be calculated by Ohm's Law (provided below as Equation 1):

I=V/R [1]

where: I=shunt current in units of Amps, V=potential difference across the conductive media in units of Volts, and R=resistance of the circuit containing the conductive media (i.e. liquid electrolyte in the present example) in units of Ohms.

From EQ. 1 it is seen that shunt currents can be minimized by reducing the potential difference and/or increasing the resistance. In a flow battery, the potential difference is governed by the number of cells with a common electrolyte path, the resistance through the common flow path section is dictated by the relationship given in Equation 2.

R=ρ*l/A [2]

where: ρ=resistivity of the medium in units of Ohm-cm, l=length of a flow channel containing the conductive medium in cm, and A=cross-sectional area of a flow channel containing the conductive medium in square cm. In a flow battery, the medium is a liquid electrolyte.

Therefore, shunt currents in an electrochemical system with a liquid electrolyte can be reduced by increasing the electrical resistance through a section of flow channel with length l and cross-sectional area A.

Therefore, in order to increase resistance (R) in a section of a flow channel, the length l of the flow channel can be increased, and/or the flow channel area (A) can be decreased. Such increases in flow channel length or decreases in flow channel area may require an increase in pumping power and fluid pressure.

Even a relatively short section of flow channel with a substantially small cross-sectional area may cause a high resistance through a selected section of an overall electrolyte flow path. Such small-area sections may act as electrical resistors in the circuit formed by a continuous flow stream of liquid electrolyte, thereby reducing overall shunt currents, or at least limiting shunt currents to sections of flow channel between such resistors.

In the various embodiments, shunt-current-reducing structures, which also referred to herein as “shunt resistors,” are configured to substantially reduce or eliminate shunt currents by creating a high electrical resistance in at least a portion of an electrolyte flow path. Some embodiments of shunt resistors described below may include an electrolyte flow channel with at least a short section having a cross-sectional area substantially approaching zero. As indicated by EQ. 2, a section with a cross-sectional area approaching zero will have an electrical resistance approaching infinity.

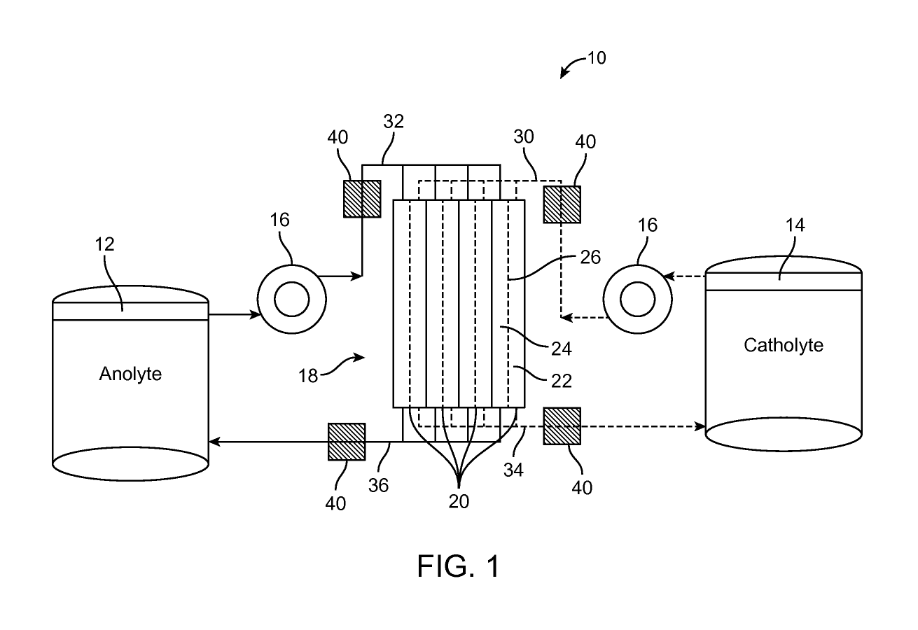

FIG. 1 schematically illustrates the hydraulic flow paths in an embodiment of a flow battery system 10. For simplicity of illustration, the electrical connections, load and power source have been omitted, and only liquid electrolyte flow paths are shown. The flow battery system 10 comprises an anolyte storage tank 12 and a catholyte storage tank 14 hydraulically connected to pumps 16, which pump the electrolytes into a block 18 of electrochemical cells 20. Each cell 20 is divided into two chambers 22, 24 by separator membranes 26. In some embodiments, the chambers 22, 24 may contain porous electrodes to collect and conduct electrical current between the reacting electrolytes and the system source or load.

In an embodiment illustrated in FIG. 1, the cells 20 are connected hydraulically in parallel. That is, in this embodiment electrolyte is directed from common inlet flow lines 30, 32 through a manifold or other structure to divide the fluid flow into each one of the plurality of half-cell chambers 22, 24 in the block 18. After passing through the cells 20 of the block 18, the electrolytes are returned to storage tanks via common outlet flow lines 34, 36 or are directed into another cell block (e.g., another stage in a cascade).

Since electrochemical reactions occur within the cells 20, there is an electric potential difference between electrolytes at the cell inlet (e.g. in the in-flow lines 30, 32) and at the cell outlet (e.g. in the out-flow lines 34, 36). In a cell block with common flow lines such as this, shunt currents will occur in the anolyte between the common anolyte inlet line 32 and the common anolyte outlet flow line 36. As described above, the magnitude of the shunt current between the anolyte inlet line 32 and the anolyte outlet line 36 will be proportional to the electric potential difference divided by the electrical resistance between those two points. In the same way, shunt currents will occur in the catholyte between the common catholyte inlet line 30 and the common catholyte outlet flow line 34, with the magnitude of such shunt currents proportional to the electric potential difference divided by the electrical resistance between those two points.

Thus, in some embodiments, it may be desirable to limit or eliminate shunt currents at desired points in an electrolyte flow path by providing structures configured to reduce shunt currents by presenting increased electrical resistance. Such structures are referred to herein as shunt resistors. Shunt resistors may be provided at selected points along the flow to reduce or eliminate shunt currents through at least selected sections of an electrolyte flow path.

A passive shunt resistor in the form of a section of flow channel that is sufficiently small to substantially eliminate shunt currents may lead to a prohibitively large pressure increase. Thus, in some embodiments, it may be desirable to use an active shunt resistor having one or more moving elements that causes a minimal increase in pressure while at least temporarily creating a section of flow channel with a cross-sectional area substantially nearly equal to zero. Embodiments and examples of such active shunt resistors are provided below.

FIG. 1 illustrates one embodiment of a flow battery system incorporating shunt resistors 40 in electrolyte flow lines. As shown, in some embodiments shunt resistors 40 may be positioned in both common inlet lines 30, 32 and common outlet lines 34, 36. In alternative embodiments, shunt resistors may be positioned in flow channels leading into and out of each individual cell.

Active or passive shunt resistors of any type are preferably made of a material that is substantially electrically non-conductive (i.e. having a substantially high electrical resistance) and chemically non-reactive (i.e. having substantially inert chemistry in the electrolyte environment). Materials useful in forming shunt resistors may include some gas bubbles (e.g., an inert gas), glass, some ceramics, rubber, or any of various non-conductive polymers, such as polyethylene, polypropylene, polyvinyl difluoride, perfluoroalkoxy, or polyvinyl chloride, among others.

In some embodiments, a plurality of cells or cell blocks may be joined to one another in a cascade arrangement such that electrolyte flows in series from one cell to another or from one cell block to another. For example, U.S. patent application Ser. No. 12/498,103, now U.S. Pat. No. 7,820,321 describes embodiments of engineered cascade redox flow battery systems in which cells and/or stacks may be arranged in cascade orientations, such that electrolyte flows in series from a first stage (or cell block) to an nth stage (where n is any number greater than one) along a common flow path. In those engineered cascade systems, a state-of-charge gradient exists between the first stage and the nth stage, and components of the electrochemical cells may be optimized based on the state-of-charge conditions expected at those cells.

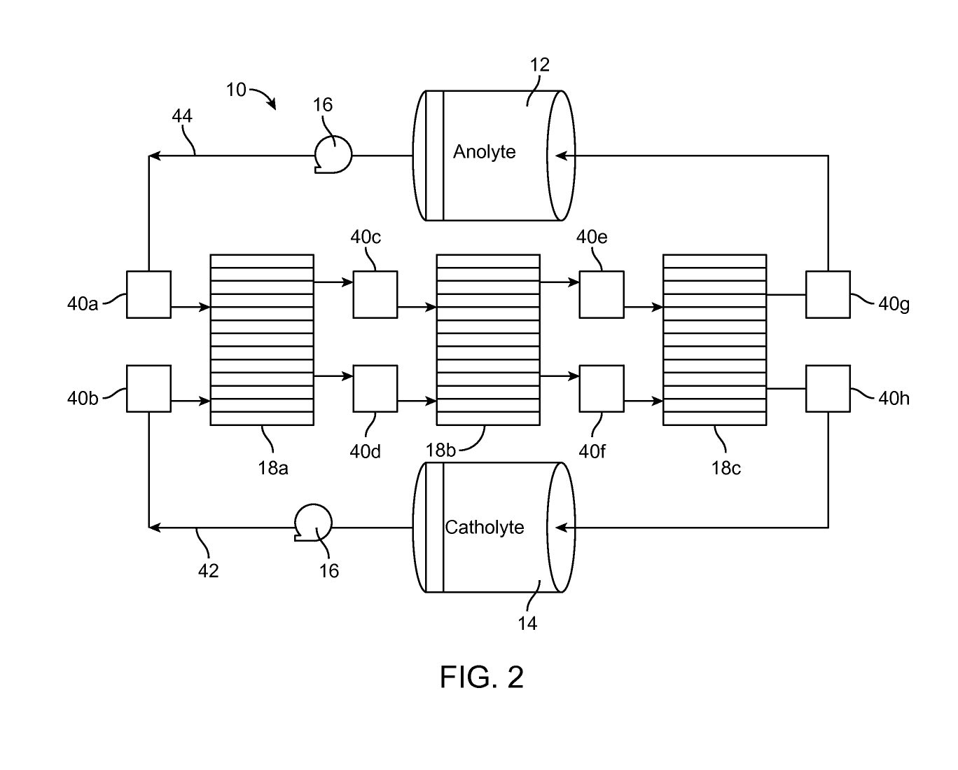

FIG. 2 illustrates an embodiment of a cascade flow battery system 10 comprising three independent cell blocks 18 hydraulically connected to one another in series. In the embodiment of FIG. 2, shunt resistors 40 may be provided in both the catholyte flow path 42 and the anolyte flow path 44 at positions before and after each cell block 18. Providing shunt resistors in this bookend arrangement advantageously prevents shunt currents from flowing across multiple cell blocks. Shunt resistors in an arrangement consistent with the embodiment illustrated in FIG. 2 may comprise any of the structures described herein.

In an alternative embodiment, shunt resistors 40 may be provided only at positions between adjacent cell blocks 18. In such an embodiment, shunt resistors 40a, 40b, 40g and 40h as shown in FIG. 2 may be omitted. In further alternative embodiments, a flow battery system may be configured such that each individual electrochemical cell within a block is isolated by one or more shunt resistors.

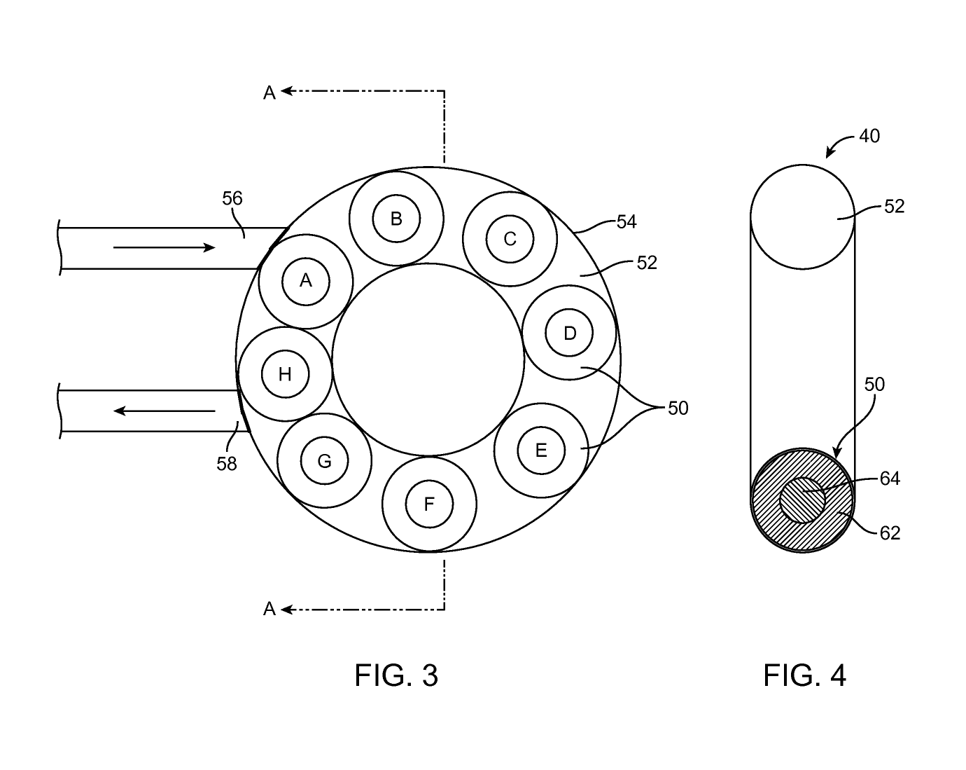

FIGS. 3 and 4 illustrate cross-sections of an embodiment of a shunt resistor 40 utilizing a plurality of dividers 50 which circulate through a channel 52 in a housing 54. The housing 54 comprises a fluid inlet 56 and a fluid outlet 58. In the illustrated embodiment, the dividers 50 may be spherical balls which may be free to move through the channel 52 in either direction. Fluid entering the shunt resistor inlet 56 will force the dividers 50 to advance through the channel 52 (in a clockwise direction as illustrated) until the fluid reaches the outlet port 58, at which point a substantial portion of the fluid between adjacent dividers 50 will exit the channel 52 though the outlet port 58.

The shunt resistor of FIGS. 3 and 4 operates by capturing fluid in the space between the dividers 50. The dividers of FIG. 3 are labeled “A” through “H” in clockwise order. As fluid enters the space between the first two dividers A and B, the space between A and B will increase as increasing fluid pressure at the inlet 56 pushes dividers B through H in a clockwise direction. The space between A and B will continue to increase until the downstream pressure forces A to begin to move in a clockwise direction. At that point, the space between A and H will increase as it fills with fluid in the same manner. As divider H moves past the outlet port 58, the fluid between dividers H and G will exit the shunt resistor through the outlet port. As fluid exits, the space between H and will decrease until dividers H and G come into physical contact.

In some embodiments, a shunt resistor such as that shown in FIG. 3 may be used to capture gas bubbles in a liquid electrolyte. In such embodiments, a gas release port may be provided at a geometric top of the device (as determined by its orientation in space relative to a force of gravity). In some embodiments, a shunt resistor may be oriented in a flow battery system such that a gas release port may coincide with the fluid outlet port 58 (e.g., by orienting an outlet port 58 at the top, and providing a gas release valve adjacent to the outlet port 58). This has the advantage of decreasing void volume (i.e. the volume of liquid through which shunt currents could flow) further, and potentially eliminating the path from the outlet 58 to the inlet 56 as a path for shunt currents, thereby substantially increasing the effective resistance.

In the embodiment illustrated in FIGS. 3 and 4, the channel 52 comprises a substantially toroidal shape (i.e., a donut shape). The toroid-shaped channel advantageously provides a circular path in which dividers 50 may circulate. In alternative embodiments, the channel 52 may comprise other shapes. For example, the channel 52 may comprise any cross-sectional shape corresponding to the dividers moving therein. The dividers may follow any desired flow path, including linear sections, elliptically curved sections, helically curved sections, or any other shape as desired. In some embodiments, the channel 52 may include a non-recirculating path.

In some embodiments, the dividers may comprise a substantially continuous three-dimensional surface having an outer cross-sectional shape substantially matching the cross-sectional shape of the channel in the direction of the dividers' travel. In some embodiments, each divider 50 may be a spherical ball as illustrated in FIGS. 3 and 4. In alternative embodiments, dividers 50 may comprise any other 3-dimensional shape as desired. For example, dividers 50 may alternatively comprise an elliptical shape when viewed in the cross-section of FIG. 3, and a circular shape when viewed in the cross-section of FIG. 4. Alternatively, a divider may be arch-shaped in a cross-section of FIG. 4. Alternatively, the channel 52 and dividers may both comprise non-circular cross-sections, such as rectangular, elliptical, cylindrical, or any other desired shape. The resulting characteristics of the desired shape such as pressure drop and degree of shunt current mitigation may be further tailored by including features like protrusions, dimples or holes in an outer surface of the dividers. In still further embodiments, a shunt resistor may be provided with dividers of different shapes as viewed in the cross-section of FIG. 4.

In alternative embodiments, dividers 50 may comprise thin paddles secured to a common rotating axle. In some embodiments, paddle-type dividers may be substantially rigid across their entire surface. In other embodiments, each paddle may comprise a flexible impermeable membrane, configured to flex or pivot in order to create a fillable space between adjacent paddles. As the axle rotates towards the outlet, the filled space will eventually reach the outlet port, at which point, fluid will flow out of the space, thereby decreasing the volume between the adjacent sheets.

In some embodiments, the dividers 50 may be sized to fit in the channel 52 with a minimum clearance in order to minimize a volume of fluid that can flow past the dividers 50. Minimizing the clearance has the effect of minimizing the cross sectional area of liquid in common communication from chamber to chamber, thus maximizing electrical resistance across a divider 50 in the channel 52. However, it is not necessary for the dividers 50 to completely seal against the channel 52. Simply having a close fit may provide the electrolyte path with a high effective resistance. For example, in some embodiments a clearance of less than about 1% may be suitable. In other embodiments, a clearance of about 0.5% or less will provide a good balance between manufacturability and maximized electrical resistance. The relative resistivity or conductivity of an electrolyte will be a function of the chosen electrolyte composition. Thus, a suitable clearance between a divider and a channel wall may be engineered for a particular electrolyte composition.

In some embodiments, the dividers 50 may comprise gas bubbles. For example, in some embodiments an inert gas may be introduced into a section of an electrolyte flow channel, thereby creating gas bubbles in the liquid. Bubbles of substantial size effectively reduce the continuous cross-sectional area of electrolyte in the flow channel, thereby increasing electrical resistance in the electrolyte. The gas may be subsequently removed from the liquid electrolyte by a bubble collector oriented vertically above the gas inlet.

In some embodiments, the dividers 50 may comprise freely moving solid objects (e.g., spheres or other shapes) made entirely of an electrically non-conductive and chemically non-reactive material that will not degrade in the electrolyte solution. In alternative embodiments, the dividers may be hollow objects with any suitable wall thickness. In some embodiments, hollow dividers may be filled with a liquid or gas (e.g., an inert gas in some embodiments). In some embodiments, a liquid or gas filling may be selected to make the dividers substantially buoyant in the electrolyte liquid. In alternative embodiments, the materials of the dividers 50 and/or any liquid or gas inside the dividers may be selected to optimize a buoyant force of the dividers in a liquid electrolyte.

In alternative embodiments, the dividers 50 may comprise a multi-layer construction. At least an outside layer 62 may be made from a substantially non-conductive and non-reactive material capable of withstanding the caustic electrolytes. The outside layer 62 may also be substantially wear resistant in order to resist degrading due to physical contact with the channel 52 over time. An outer layer 62 of a multi-layer divider 50 may be any thickness as needed.

In further alternative embodiments, the dividers 50 may comprise an internal core 64 made of a metallic or ceramic material. In other embodiments, the internal core may be a non-metallic and non-conductive material, a ferrous metal, a magnetic material, hollow, or any other desired material.

In some embodiments, inlet 56 and outlet 58 port dimensions may be designed such that the fluid speed (or flow rate) in the ports 56 and 58 are equal to one another, and also the same as the fluid speed in the channel 52. In other embodiments, the inlet 56 and outlet 58 ports may be sized and configured such that the fluid speed in the ports 56 and 58 are equal to one another but greater than the fluid speed in the channel 52. In other embodiments, the inlet 56 and outlet 58 ports may be sized and configured such that the fluid speed in the ports 56 and 58 are equal to one another but less than the fluid speed in the channel 52. In other embodiments, the inlet 56 and outlet 58 ports may be sized and configured such that the fluid speed in the ports 56 and 58 are not equal to one another and the fluid speed in the channel 52 is greater than the fluid speed in at least one of the inlet and outlet ports 56, 58. In other embodiments, the inlet 56 and outlet 58 ports may be sized and configured such that the fluid speed in the ports 56 and 58 are not equal to one another and the fluid speed in the channel 52 is less than the fluid speed in at least one of the inlet and outlet ports 56, 58.

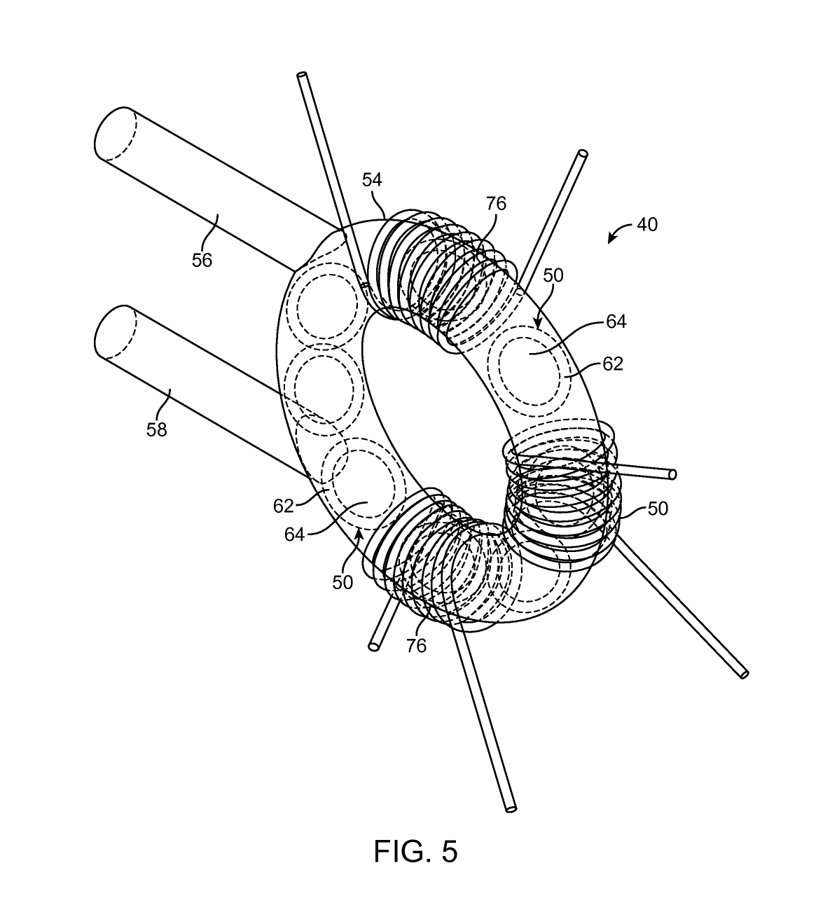

As suggested by Equations 1 and 2 above, the effectiveness of a shunt resistor can be expressed as a sum of electrical resistances through sections of the flow path. In the case of shunt resistors with multiple sections of fluid cross-sectional area substantially nearly equal to zero, the electrical resistance of those zero-area sections will substantially dominate the summation equation. Such nearly-zero area sections may include the areas between the dividers and the channel wall in the embodiments of FIGS. 4 and 5, the “pinched area” in a peristaltic pump, or the area between gears or screw elements of a positive displacement pump. Therefore, the total electrical resistance through a shunt resistor may be substantially approximated by the equation:

R_{SB}=Σ1/A_{min 1}+ . . . +1/A_{min n} [3]

The shunt resistor resistance R_{SB} can be substantially approximated by the sum of the inverses of the minimized areas. Thus, in the embodiment of FIGS. 3 and 4 and other embodiments comprising multiple dividers of equal size relative to a flow channel, the shunt resistor resistance will be approximated by the number of dividers multiplied by the clearance area between the dividers and the flow channel internal wall.

For example, one embodiment of a shunt resistor such as that illustrated in FIGS. 3 and 4 comprises a channel cross-section diameter of 0.377″ and a mean toroid diameter of 5″ (i.e. the mean between the inner channel diameter and the outer channel diameter as viewed in the cross-section of FIG. 4). This embodiment also comprises 41 spherical dividers 50, each having an external diameter of 0.375″ fit. According to this embodiment, the inlet and outlet ports each have a diameter of 0.321″ in order to match fluid speed. In this embodiment, there is a total void volume (i.e. channel volume not occupied by dividers) in the channel of 0.6 cubic inches. This embodiment would have an equivalent shunt resistance of a 0.30″ diameter tube 34″ long, with a volume of 2.4 cubic inches but a smaller pressure drop. In a six stage cascade stack of 13 cells in each stage, the reduction in shunt current losses from the increased resistance in the shunt resistor would increase energy efficiency by 1 to 2 percent.

The embodiment of FIGS. 3 and 4, as well as the other pump and flow meter types of shunt resistors described above, advantageously occupy substantially less system volume and cause a substantially smaller pressure drop than an equivalent long-channel shunt resistor. In addition, these shunt resistor embodiments have less liquid hold-up compared with alternative methods, thus improving the dynamic response of a series of electrochemical cell blocks to a change in system charge or discharge power. Some embodiments of the FIG. 3 shunt resistor also advantageously provide continuous electrolyte flow with minimal unwanted flow restrictions, while also allowing substantial control of flow rate resistance through the shunt resistor.

In some embodiments, it is desirable to control the rate at which fluid electrolytes flows through the shunt resistor. This may be achieved by introducing a frictional or drag force to one or more moving elements of a shunt resistor.

For example, FIG. 5 illustrates a shunt resistor 40 comprising a plurality of powered coils 76 surrounding sections of the shunt resistor channel 54. In this embodiment, the dividers 50 comprise a magnetic core material (which may be a ferrous, ceramic, rare earth or other magnetic material). The dividers 50 of this embodiment also comprise a non-spherical, elongate shape, selected and arranged such that the magnetic poles of the core material are aligned with a longitudinal axis of the dividers.

Applying an electric current to one of the coils 76 will induce a magnetic field according to the right hand rule, as will be clear to the skilled artisan. The induced magnetic field will attract opposite poles and repel like poles of the magnetic cores of adjacent dividers 50. By controlling the timing of the application of electric currents to each of the coils 76, the induced magnetic fields may be controlled to apply magnetic forces which predominantly resist forward motion of the dividers through the channel 54. Varying the magnitude of the electric currents applied to the coils 76 will vary the magnitude of magnetic forces applied to the dividers 50. Thus, by controlling the timing and magnitude of applied electric currents, the device of FIG. 5 may control the rate of flow of circulating electrolytes, thereby controlling the back pressure of fluid flowing between the inlet 56 and the outlet 58. Similarly, the device of FIG. 5 may be operated as a pump to increase a rate of electrolyte flow from the inlet 56 to the outlet 58.

In alternative embodiments, a drag force may be applied to rotating shunt resistor elements through the use of mechanical or electromechanical means. For example, in embodiments where a rotating element is attached to a rotating shaft or axle, a brake or a clutch may be configured to apply a frictional force to resist the rotating motion, or an electromagnetic force may be applied as in an electric motor to resist the rotation. Alternatively, a magnetic force may be applied which causes increased friction between the dividers 50 and the channel's inner wall, thereby causing controlled resistance to flow. Alternatively or in addition, a positive force may be applied to the rotating shaft or the dividers to assist flow if desired to overcome flow resistance in the system and control flow to a desired rate in each of the flow streams.

In another embodiment, an entire flow battery system may be controlled in a “pulsed-flow” manner. Whereas in previous embodiments, a pump moved electrolyte at a constant flow rate throughout the flow battery system, it is also possible to achieve the pulsed-flow through the entire system by temporarily halting electrolyte flow through an entire stack, or through the entire flow battery. In this embodiment, one-way shunt current valves may be positioned at inlet and outlet positions of each cell. The shunt current valves may be configured to prevent backflow and un-wanted drainage from the cells. The shunt current valves, made of electrically non-conductive materials, will also isolate each cell from un-wanted shunt currents.

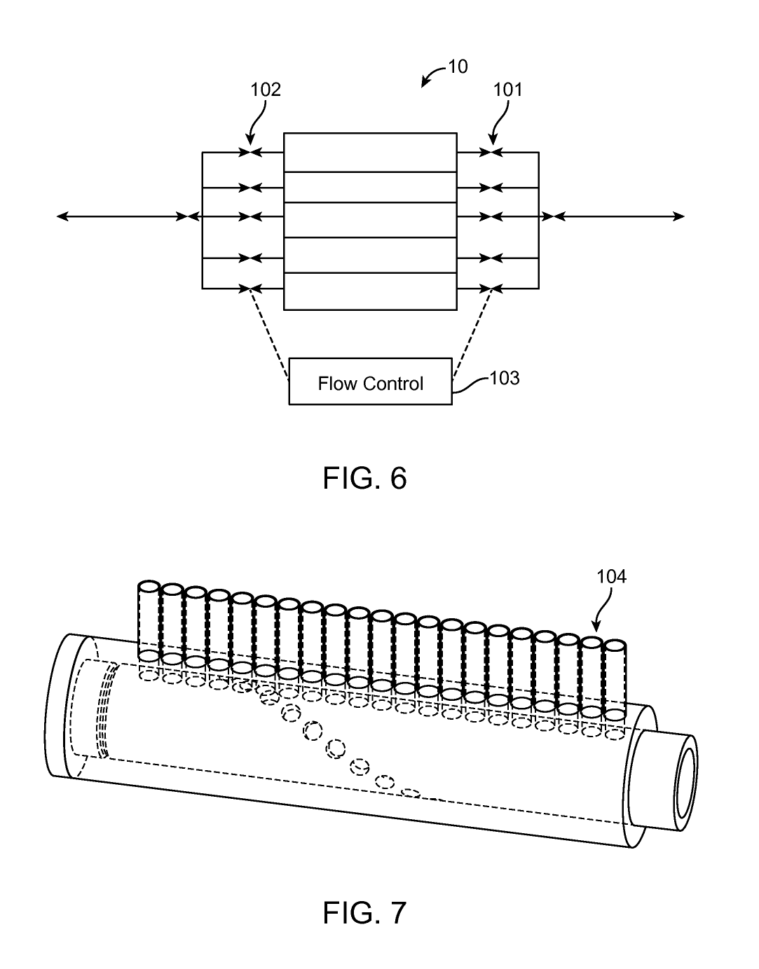

A shunt current valve is any single valve or series of valves controlling flow to and from one or more cells in a stack. The operation is described below with reference to FIGS. 6 and 7.

Take for example a group of 10 cells as shown in FIG. 6. Each cell has an entry and exit valve 101, 102 with an open and closed state that is out of phase with all adjacent cells in the stack such that only one cell (or more than one, but less than all cells) has electrolyte flowing through it at any given time. Under operation, the valves cycle on and off in the pattern, one, then two, then three, then four, etc. After ten (10) the valves cycle back to one and start over. During each cycle, the inlet and outlet valves should remain open long enough to completely or nearly replace the electrolyte in a single cell. The exact time will vary depending on the flow rates and characteristics of the cells and system involved. In some cases it may be desirable for the valves to be open long enough to pump more than the volume of one cell through the cell before closing the valves. This will have the effect of ensuring that, when the valves close, the cell will contain only new electrolyte. The pump may be operated at a constant flow rate sufficient to pump electrolyte through the one or few cells that are open to flow at any given instant. This has the advantage of reducing the required pump size, since the system flow rate need only be sufficient to pump electrolyte through one cell of the group at any single instance in time rather than all cells of the group simultaneously.

In some embodiments, a flow resisting device may be configured to act as a shunt current resistor under control of a flow controller 103 that measures flow, causes resistance to the flow, or positively pumps the flow. In some embodiments, flow resistors may comprise similar structures to pumps, but may be different in that a flow resistor need not necessarily be capable of producing a positive pumping pressure between its inlet and its outlet. Rather a flow resistor may be any electromechanical device which creates a back-pressure to resist fluid flow through it. In some embodiments, flow resistors may also be configured to produce a variable back pressure that may be manually or automatically controlled, thereby enabling flow measurement and/or flow control in addition to the shunt resistance function.

FIG. 7 illustrates one embodiment of a unified shunt current valve comprising a rotating cylinder set 104. Entry and exit valves (i.e. two valves per electrolyte for a total of four per stack) may be synchronously timed to open and close together by cylinder rotation. The rotating valve is configured to allow electrolyte flow to only one cell at a time. As the cylinder rotates a port on the valve aligns with its respective cell and fluid is allowed to flow through the valve only in that cell. As the cylinder continues to rotate, the next cell receives a fluid injection, etc. Faster and slower rotation of this valve controls the pulse duration (e.g. the time between pulses injected into a single cell). Volumetric flow rate of the system will be controlled by a pump. Other mechanical valve arrangements may be devised to synchronously open and close valves to isolate electrolyte flow to a single cell at a given time.

One-way check valves, such as duck-bill valves, “pinch” valves, flapper valves, poppet valves, etc. may be used at inlet and/or outlet positions to prevent back-flow, cell drainage or other undesirable flow conditions.

A similar effect may be achieved by placing individual electronically-actuated valves at inlet and outlet positions on each cell, and electronically controlling the opening and closing of the valves such that electrolyte flows through only one cell at a time, thereby isolating shunt currents to a single cell.

Either a mechanical or electronic valve set may be arranged to allow electrolyte to flow through more than one, but less than all of the cells at one time, thereby isolating any shunt currents only to the simultaneously-flowing cells. Ideally, the number of cells flowing at one time will be optimized for system output, pumping conditions and shunt current mitigation.

The various embodiments of devices, systems and methods described herein may be used with any reactant combinations that include at least one liquid electrolyte. One example is a stack containing the vanadium reactants V(II)/V(III) or V 2+/V 3+ at the negative electrode (anolyte) and V(IV)/V(V) or V 4+/V 5+ at the positive electrode (catholyte). The anolyte and catholyte reactants in such a system are typically dissolved in sulfuric acid. This type of battery is often called the all-vanadium battery because both the anolyte and catholyte contain vanadium species. Other combinations of reactants in a flow battery that may utilize the embodiment cell and stack designs include Sn (anolyte)/Fe (catholyte), Ti (anolyte)/Fe (catholyte), Mn (anolyte)/Fe (catholyte), V (anolyte)/Ce (catholyte), V (anolyte)/Br 2 (catholyte), Cr (anolyte)/Br 2 (catholyte), Fe (anolyte)/Br 2 (catholyte), S (anolyte)/Br 2 (catholyte), Zn (anolyte)/Br 2 (catholyte), Zn (anolyte)/Cl 2 (catholyte), flowing zinc-air (i.e. Zn (anolyte)/O 2 (catholyte)) and semi-solid lithium ion chemistries (i.e. suspensions of Li-ion intercalation materials such as hard carbons, lithium titanate, lithium iron phosphate, LiCoO 2). In each of these example chemistries, the reactants are present as dissolved ionic species in the electrolytes, which permits the use of battery cell and stack designs in which electrolyte flow through a plurality of battery cells series along the flow path (i.e., cascade flow), with the cells and having different physical properties along the flow path (cell size, type of membrane or separator, type and amount of catalyst). A further example of a workable redox flow battery chemistry and system is provided in U.S. Pat. No. 6,475,661, the entire contents of which are incorporated herein by reference.

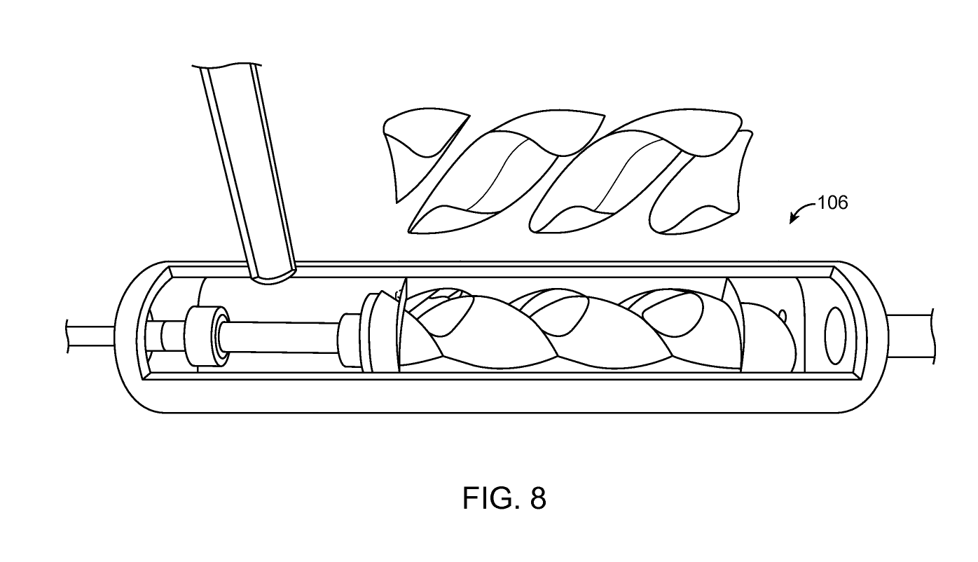

In one embodiment, a shunt resistor may comprise one or more peristaltic pumps. In FIG. 8, a progressing cavity pump 106 is depicted. A peristaltic pump moves a non-compressible fluid through a flow channel by mechanically compressing a small section of flexible tubing, and advancing the point of compression along the flexible tubing in the direction of desired flow. Many designs and embodiments of peristaltic pumps are known in the art. For example, U.S. Pat. Nos. 4,522,571 and 4,702,679 illustrate and describe two examples of peristaltic pumps.

To be useful as a shunt resistor, an internal cross-sectional area of the pinched section of tubing may be reduced substantially to zero. A complete reduction in cross-sectional area is not necessary, since a sufficiently small cross-sectional area will create a sufficiently high electrical resistance to act as a shunt resistor. Thus, the electrical resistance of the minimized cross-sectional area may be balanced with the need to minimize system cost and complexity to reach an optimal result.

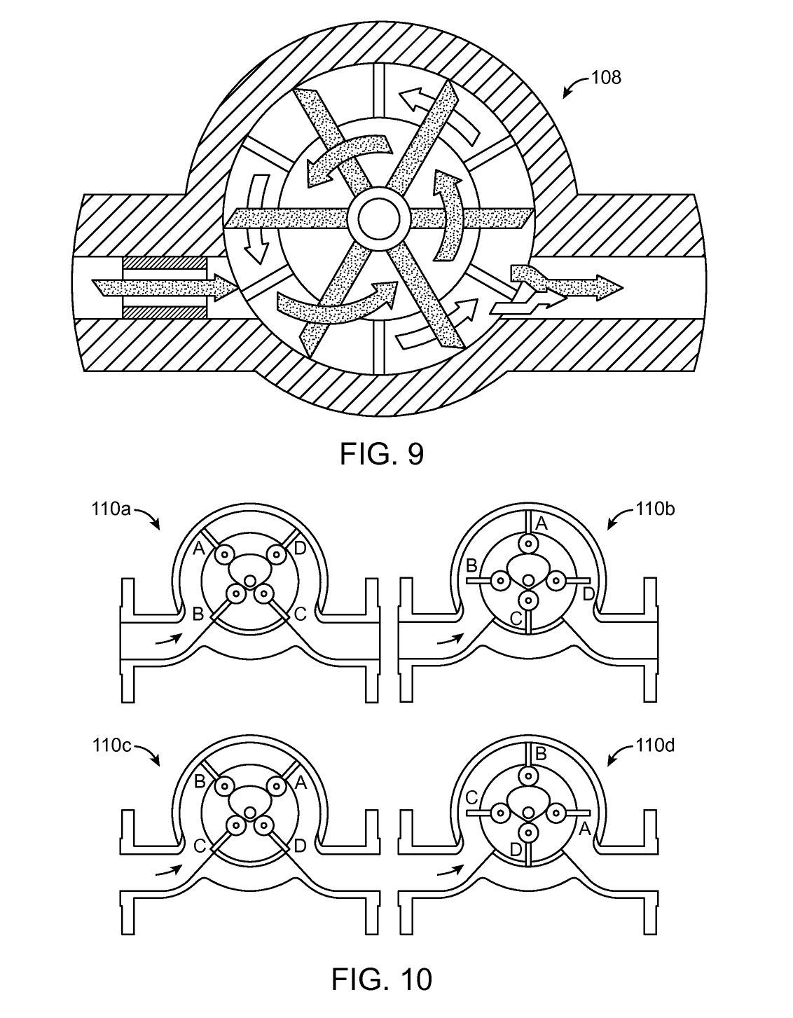

In alternative embodiments, one or more positive-displacement pumps may be configured and used as shunt resistors as described herein, an example of which is positive-displacement pump 108, illustrated in FIG. 9. A sequence of operation of a positive-displacement pump is illustrated in FIG. 10 at 110a-110d. In some embodiments, positive displacement pumps have a shaft that transmits the rotation of a moving element which closes off a volume in the flow path. In this embodiment, the shaft rotates as the volume is passed through the device. For a positive-displacement pump to function as a shunt resistor, a fluid volume enclosed by the pumping element(s) will be sufficiently isolated so that any continuous fluid volume path across the positive displacement pump elements (“bypass area”) will be very small in cross-sectional area. Any bypass area is preferably sufficiently small so that an electrical resistance will be high, thereby forming a shunt resistor.

Similarly, in some embodiments positive-displacement flow meters may be used as shunt resistors provided a bypass volume is sufficiently small. In either positive-displacement pumps or positive-displacement flow meters, non-conductive materials may be used for the wetted parts of the positive displacement device to provide electrical insulation and isolation of the inlet from the outlet of the device when used as a shunt resistor. Many embodiments of positive displacement pumps and flow meters are well-known in the art. Examples of suitable positive-displacement pumps and flow meters include gear pumps, screw pumps and other progressing cavity pumps (“Moyno” pump). For example, U.S. Pat. No. 7,104,770 illustrates and describes embodiments of a screw pump, and U.S. Pat. Nos. 5,145,349, 6,047,684, and 7,976,297 illustrate embodiments of gear pumps. In other embodiments, a paddle wheel pump, such as shown and described in U.S. Pat. No. 4,411,591, may be used as a shunt resisting pump or flow meter.

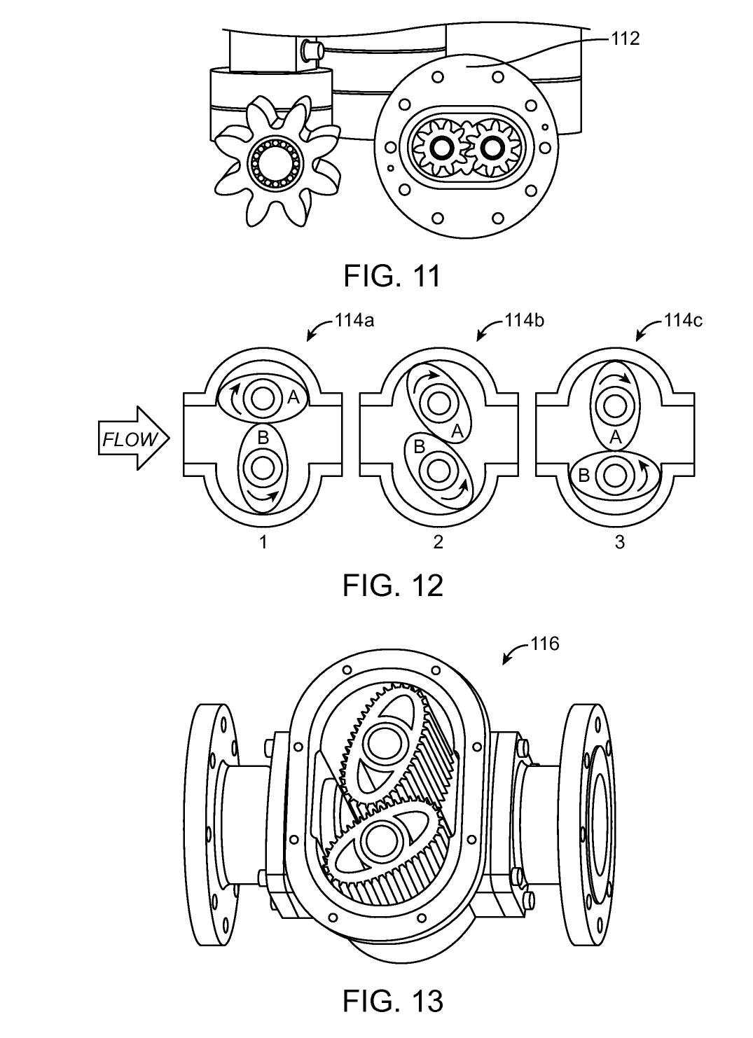

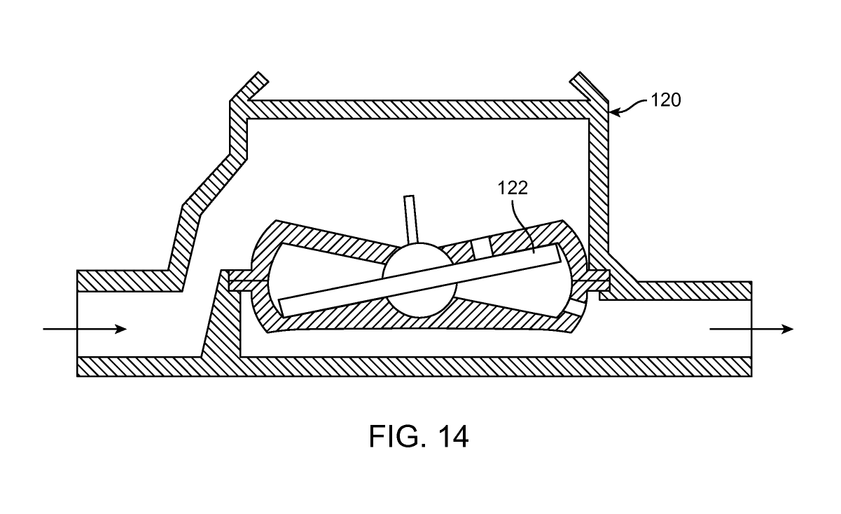

Additional examples of positive-displacement flow control devices are illustrated in FIGS. 11-13. For example, FIG. 11 illustrates a gear pump 112 which features two enmeshed spur gears. FIG. 12 illustrates a sequence of gear positions of an oval gear pump 114a-114c. FIG. 13 illustrates a toothed oval gear pump in which two rotating oval gears with synchronized teeth “squeeze” or meters a finite amount of fluid through the device with each revolution. Positive-displacement flow meters may also be configured from gears similar to those illustrated in FIGS. 11-13, with motion of the gears accomplished by fluid pressures from the electrolyte flowing through the pumps. Also, those shunt resistor devices including mechanical drives may be configured to move the electrolyte through the device with minimal resistance, but not necessarily to “pump” or add to the hydraulic pressure in the system. In some embodiments, positive displacement flow control devices may be configured to resist hydraulic flow through the device by including mechanical, electromechanical or electromagnetic devices to introduce friction to a positive displacement device. FIG. 14 illustrated another example of a shunt resister device in the form of a nutating disk flow meter 120. This nutating disk flow meter 120 includes a nutating disk 122, which is a disk mounted on a sphere that is “wobbled” about an axis by the fluid flow. Each rotation enables a finite amount of fluid to be transferred through the device. However, the nutating disk 122 provides a physical isolation between the inlet and the outlet which functions as a shunt resistor.

In the embodiments and examples discussed above, the moving fluid-isolating structures, which restrict the fluid flow to create fluidic isolation of the inlet from the outlet, are configured from non-conductive materials so that the structures themselves present high resistance to electricity. The fluid isolation substantially reduces electrical flow (i.e., shunt currents) through the electrolyte, while the high resistance materials of the moving fluid-isolating structures minimizes electrical flow through the shunt resistor device (i.e., through the moving structure itself).

In some embodiments, a flow resisting device may be configured to act as a shunt current resistor. In some embodiments, flow resistors may comprise structures similar to those of pumps, but different in that a flow resistor need not be capable of producing a positive pumping pressure between its inlet and its outlet. Rather a flow resistor may be any electromechanical device which creates a back-pressure to resist fluid flow through the device. In some embodiments, flow resistors may also be configured to produce a variable back pressure that may be manually or automatically controlled, thereby enabling flow measurement and/or flow control in addition to the shunt resistance function.

In alternative embodiments, a shunt resistor may include a reciprocating piston or oscillating piston that is fluidically, mechanically or magnetically operated to fill a cylinder with electrolyte fluid received from an inlet and then discharge the fluid through an outlet. In this embodiment, each stroke of the piston represents a finite measurement of the fluid, while the piston and valves of the device serve to electrically isolate the inlet from the outlet.

In the embodiments described above the shunt resistor includes a structure which substantially isolates the electrolyte at the inlet of the device from electrolyte at the outlet of the device. This fluidic isolation is accomplished by mechanical mechanisms, such as physically squeezing the flow channel closed or substantially closed, or by forming a moving boundary through which fluid flow is restricted. In general, an active shunt resistor device includes a structure that minimizes a cross section of liquid in communication between chambers within the device. The examples discussed above include a gear pump, a screw pump, a paddle pump, a peristaltic pump, a progressive cavity pump, a piston pump, a diaphragm pump, a positive-displacement flow meter, and a nutating disk flow meter.

It may be physically impossible to completely isolate fluids on both sides of such moving boundaries. However, minimizing the area of the flow path through the moving boundary sufficiently to substantially restrict the fluid flow through or around the boundary using electrically resistive structures will, in general, present sufficient electrical resistance to electrical currents flowing through any electrolyte that does seep through the boundary for the device to function as a shunt resistor in the various embodiments. To reflect the possibility of some leakage fluid flows through or around the moving fluid boundary in a shunt resistor, the term “substantial” is used in this description and the claims to refer the amount or fluid isolation, flow restriction or resulting electrical resistance. For purposes of this disclosure, “substantial” means to a large degree sufficient to provide electrical resistance to shunt currents through the shunt resistor device, as would be understood by one of skill in the art of flow batteries in view of the descriptions provided herein.

In the descriptions above and in the claims, references to flow channels is meant to include piping, tubing, ducts and channels that may be external or internal to electrochemical cell blocks, including piping or channels between electrochemical cell blocks. In particular, the term “flow channel” is not intended to refer to internal channels within a cell block, unless specifically described as such.

In alternative embodiments, a shunt resistor may be configured to serve primarily as a shunt resistor, while also providing other functions, such as pumping, flow metering, resisting flow, flow measurement, electrolyte analysis, de-gassing, etc.

As used herein, the terms “about” or “approximately” for any numerical values or ranges indicates a suitable temperature, dimensional or other range defining a tolerance that allows the element or elements to function for their intended purpose as described herein.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Various modifications to the above embodiments will be readily apparent to those skilled in the art, and the generic principles defined herein may be applied to other embodiments without departing from the spirit or scope of the invention. Thus, it is intended that the scope of the present invention herein disclosed should not be limited by the particular disclosed embodiments described above, but should be determined only by a fair reading of the claims that follow.

In particular, materials and manufacturing techniques may be employed as within the level of those with skill in the relevant art. Furthermore, reference to a singular item, includes the possibility that there are plural of the same items present. More specifically, as used herein and in the appended claims, the singular forms “a,” “and,” “said,” and the include plural referents unless the context clearly dictates otherwise. As used herein, unless explicitly stated otherwise, the term “or” is inclusive of all presented alternatives, and means essentially the same as the commonly used phrase “and/or.” Thus, for example the phrase “A or B may be blue” may mean any of the following: A alone is blue, B alone is blue, both A and B are blue, and A, B and C are blue. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

What is claimed is:

1. A flow battery system, comprising:
a first block of electrochemical cells arranged along a first electrolyte flow channel and comprising a first inlet and a first outlet and containing a first electrolyte;
a first active shunt resistor device positioned in the first electrolyte flow channel at the first inlet to the first block of electrochemical cells; and
a second active shunt resistor device positioned in the first electrolyte flow channel at the first outlet from the first block of electrochemical cells.

2. The flow battery system of claim 1, further comprising:
second block of electrical chemical cells arranged downstream along the first electrolyte flow channel and comprising a downstream first inlet that communicates with the second active shunt resistor device and comprising a downstream first outlet; and
a downstream active shunt resistor device positioned in the first electrolyte flow channel at the downstream first outlet from the second block of electrochemical cells.

3. The flow battery system of claim 1, wherein the first block of electrochemical cells is arranged along a second electrolyte flow channel comprising a second inlet and a second outlet and containing a second electrolyte; the flow battery system further comprising:
a third active shunt resistor device positioned in the second electrolyte flow channel at the second inlet to the first block of electrochemical cells; and
a fourth active shunt resistor device positioned in the second electrolyte flow channel at the second outlet from the first block of electrochemical cells,
wherein the first electrolyte comprises a catholyte and the second electrolyte comprises an anolyte.

4. The flow battery system of claim 3, further comprising:
a second block of electrochemical cells arranged along the first electrolyte flow channel and the second electrolyte channel in hydraulic series with the first block of electrochemical cells, the second block of electrochemical cells comprising:
a downstream first inlet that communicates with the second active shunt resistor device;
a downstream first outlet in fluid communication with the downstream first inlet;
a downstream second inlet that communicates with the fourth active shunt resistor device;
a downstream second outlet in fluid communication with the downstream second inlet;
a first downstream active shunt resistor device positioned in the first electrolyte flow channel at the downstream first outlet; and
a second downstream active shunt resistor device positioned in the first electrolyte flow channel at the downstream second outlet.

5. The flow battery system of claim 1, wherein the first and second active shunt resistor devices each comprises a structure that minimizes a cross section of liquid in communication between chambers within the device.

6. The flow battery system of claim 5, wherein the first and second active shunt resistor devices are selected from the group consisting of a gear pump, a screw pump, a paddle pump, a peristaltic pump, a progressive cavity pump, a piston pump, a diaphragm pump, a positive-displacement flow meter, and a nutating disk flow meter.

7. The flow battery system of claim 1, further comprising a flow controller in communication with the first and second active shunt resistor devices and configured to measure flow of the first electrolyte.

8. The flow battery system of claim 1, further comprising a flow controller in communication with the first and second active shunt resistor devices and configured to selectively resist flow of the first electrolyte.

9. The flow battery system of claim 1, further comprising a flow controller in communication with the first and second active shunt resistor devices and configured to selectively pump of the first electrolyte.

10. The flow battery system of claim 1, wherein the first and second shunt resistor devices comprise a flow channel having a substantially toroidal shape and a plurality of independent dividers positioned within the flow channel, wherein each divider is free to move within the toroidal flow channel.

11. A device for substantially eliminating shunt currents in an all-liquid redox flow battery system, the device comprising:
an electrolyte flow channel having an inlet and an outlet; and
at least one element positioned within the electrolyte flow channel between the inlet and the outlet that reduces a cross-sectional area of the flow channel to substantially zero.

12. The device of claim 11, wherein the electrolyte flow channel comprises a substantially toroidal shape, and
wherein the at least one element comprises a plurality of independent dividers positioned within the electrolyte flow channel, wherein each divider is free to move within the electrolyte flow channel.

13. A flow battery system, comprising:
a block of electrochemical cells arranged along a electrolyte flow channel; and
a shunt resistor device positioned within the electrolytic flow and having an inlet and an outlet, the shunt resistor device comprising a structure which presents a substantial electrical resistance to electrical currents flowing through the shunt resistor device while enabling electrolyte to flow through the device.

14. The flow battery system of claim 13, wherein the structure which presents a substantial electrical resistance to electrical currents flowing through the shunt resistor device while enabling electrolyte to flow through the device comprises a structure that minimizes a cross section of liquid in communication between chambers within the shunt resistor device.

15. The flow battery system of claim 14, wherein the shunt resistor device is selected from the group consisting of a gear pump, a screw pump, a paddle pump, a peristaltic pump, a progressive cavity pump, a piston pump, a diaphragm pump, a positive-displacement flow meter, and a nutating disk flow meter, and wherein the structures of the shunt resistor device are fabricated from a material exhibiting high electrical resistance.
